(19) United States
(12) Patent Application Publication
(10) Pub. No.: US 2011/0079617 A1
(43) Pub. Date: Apr. 7, 2011

(54) ACTUATION DEVICE FOR A SPRAY CAN

(76) Inventors: Kenneth Wendel QUARLES, Chatsworth, GA (US); Mike D. WHITAKER, Chatsworth, GA (US)

(21) Appl. No.: 12/894,549

(22) Filed: Sep. 30, 2010

Related U.S. Application Data
(60) Provisional application No. 61/247,741, filed on Oct. 1, 2009.

(51) Int. Cl. B65D 83/18; B23P 19/00

(52) U.S. Cl. 222/402.15; 29/267

(57) ABSTRACT

The present invention provides an actuation device for a spray can of the type comprising a curl portion at the top of the spray can and a nozzle through which a pressurized fluid is dispensed through a top portion thereof. The actuation device includes a lever. The lever has an elongated slot through a portion thereof for receiving a portion of the nozzle. The lever also has a handle at one end and an engaging surface at the other end. The engaging surface engages the curl of the spray can and securely holds the actuation device on the spray can. When a force is applied to the handle to urge the handle towards the spray can, the lever depresses the nozzle to thereby dispense the pressurized fluid therethrough.

### CROSS REFERENCE TO RELATED APPLICATION

This application claims priority to U.S. Provisional Patent Application Ser. No. 61/247,741, filed Oct. 1, 2009, which is hereby incorporated herein by reference in its entirety for all purposes.

### TECHNICAL FIELD

The present invention relates generally to the field of spray cans, and more particularly to an actuation device for a spray can.

### BACKGROUND

Spray cans have been known for years to dispense the fluids housed therein. Spray cans have many applications, including dispensing fluids such as, but not limited to, adhesives, paints, cleaners, deodorants, hair sprays, and insecticides. A typical spray can has a nozzle through which the pressurized fluid in the can is dispensed. Traditionally, to activate the nozzle, the user would press the nozzle with his or her finger to thereby dispense the fluids. However, with such systems, it can be difficult for a user to apply a constant pressure to the nozzle so as to dispense a large volume of the contained fluid in an even pattern. Also, by applying pressure to the nozzle with a finger, the user's finger or hand often becomes coated with the sprayed fluid. This can be quite messy, especially if the fluid is a paint or adhesive.

Accordingly, it can be seen that needs exist for improved actuators for spray cans. It is to the provision of meeting these needs and others that the present invention is primarily directed.

### SUMMARY OF THE INVENTION

In an example embodiment, the present invention provides a system for dispensing a fluid. The system includes a spray can having an upper curl portion and a can body that houses a pressurized fluid. A nozzle is coupled to the spray can for dispensing the pressurized fluid therethrough, and an actuation lever is attached to the can. The nozzle further includes first and second portions, wherein the first portion of the nozzle has a smaller cross-sectional dimension than a cross-sectional dimension of the second portion. The actuation lever further includes a proximal end, a distal end, an elongated slot extending along a portion thereof and configured to receive at least the first portion of the nozzle therethrough, and an engaging surface extending from the proximal end of the lever. The engaging surface engages the curl portion of the can and at least partially secures the lever to the can. Thus, when a force is applied to the distal end of the lever to urge the lever towards the can, the lever depresses the nozzle to thereby dispense the pressurized fluid therethrough.

In another aspect, the present invention provides an actuation device for a spray can having a push-button nozzle. The actuation device includes a substantially U-shaped hinge having first and second arms, wherein the first arm includes a yoke for attachment to the spray can and the second arm includes an opening therethrough. The opening is dimensioned to receive a portion the nozzle therethrough. The actuation device further includes a handle extending at an oblique angle from the second arm. Thus, the actuation device is fitted to the can such that the yoke engages the can, the portion of the nozzle is positioned through the opening, and upon a force being applied to the handle to urge the handle towards the can, the second arm depresses the nozzle to thereby dispense a fluid therethrough.

In yet another aspect, the present invention provides a kit. The kit includes a spray can housing a pressurized fluid therein, a two-part nozzle, and an actuation device. The spray can has a curl near a nozzle assembly. The two-part nozzle includes a first part of the nozzle that has a smaller cross-sectional dimension than a cross-sectional dimension of a second part of the nozzle. The actuation lever includes a first portion, an opening in the first portion, wherein the opening is configured to receive at least the first part of the two-part nozzle, a handle extending from a first end of the first portion, and an engaging surface extending from a second end of the first portion, wherein the engaging surface is configured to engage the curl of the can to secure the lever to the can.

In still another aspect, the present invention provides a spray can of the type comprising a curl portion at the top of the can and a nozzle through which a pressurized fluid is dispensed through a top portion thereof. The improvement therein includes an actuation device removably attached to the curl of the can. The actuation device comprises a lever, wherein the lever has a first portion having an opening extending therethrough and a second portion extending from the first portion for providing a handle, and an engaging surface at a proximal end of the lever, wherein the engaging surface engages the curl of the can. When a force is applied to the handle to urge the handle towards the can, the lever depresses the nozzle to thereby dispense the pressurized fluid therethrough.

These and other aspects, features, and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### DETAILED DESCRIPTION OF THE DRAWINGS

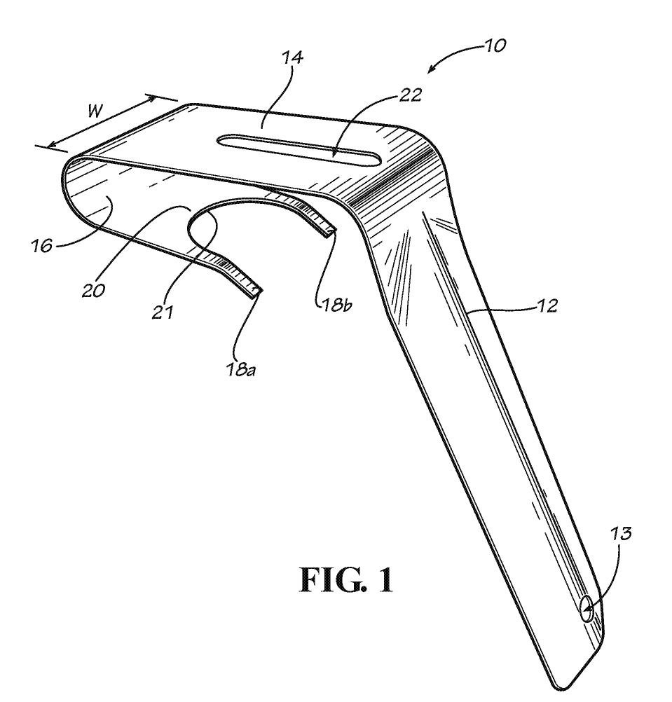

FIG. 1 is a perspective view of an actuation device for a spray can according to an example embodiment of the present invention.

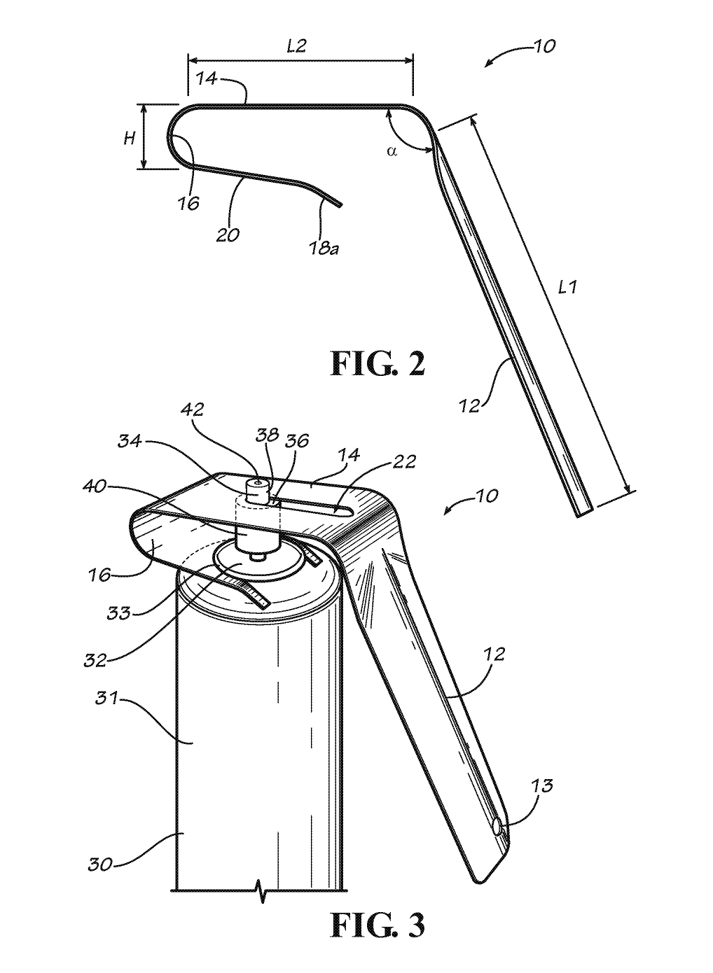

FIG. 2 is a side view of the actuation device of FIG. 1.

FIG. 3 is a perspective view of the actuation device of FIG. 1 shown attached to a spray can.

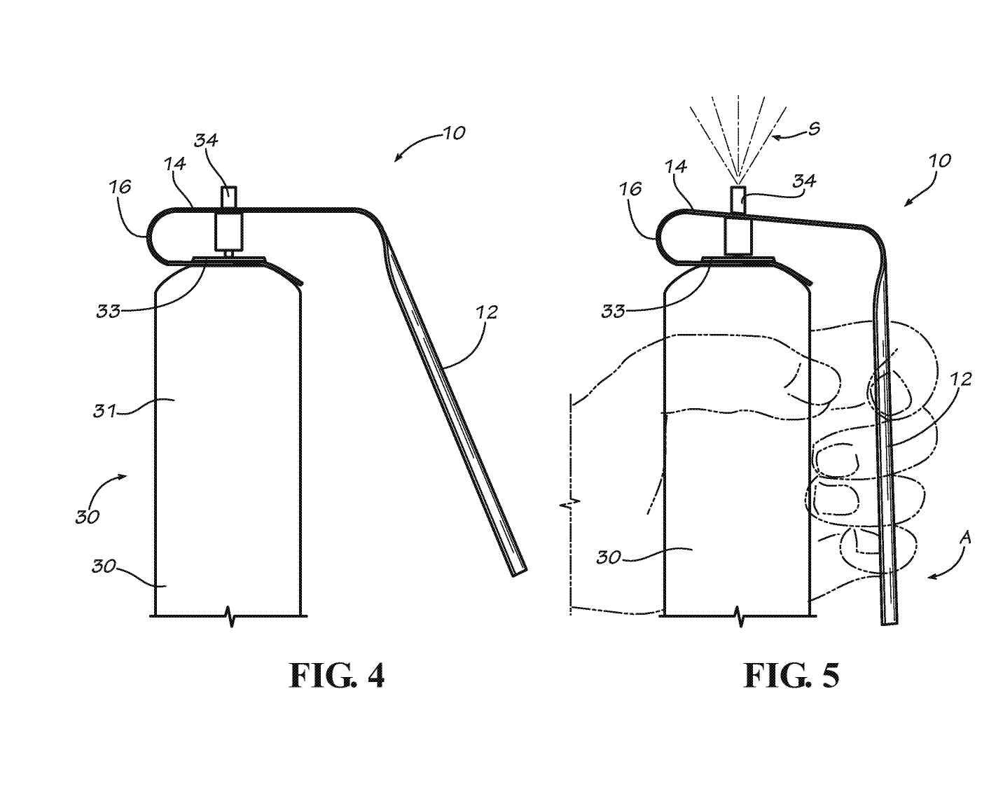

FIG. 4 is a side view of the actuation device and spray can of FIG. 3.

FIG. 5 is a side view of the actuation device and spray can of FIG. 3 shown being operated by a user.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

With reference now to the drawing figures, wherein like reference numbers represent corresponding parts throughout the several views, FIGS. 1-5 show a spray can actuation device 10. In example embodiments, the spray can actuation device 10 can be removably attached to any existing spray can, such as but not limited to an aerosol can, having a spray nozzle/actuator. For example, the actuation device 10 can be used in conjunction with a spray can 30, as shown in FIGS. 3-5, which generally comprises a substantially cylindrical housing or body 31 having a valve cup 32 with a curl 33 near the top periphery of the housing. The valve cup 32 is the portion of the can where the actuator/valve attaches to the can body 31. Though the can 30 of the depicted embodiment is substantially cylindrical, any suitably sized and shaped spray can may be employed and be within the scope of the present invention. As is typical with known spray cans, the spray can 30 of the present invention houses at least one pressurized fluid therein.

The can 30 further comprises an actuator, head, or nozzle 34 through which pressurized fluid is dispensed therethrough. Preferably, the actuator 34 is a two-part push-button nozzle (or “vertical spray tip”) such that when the actuator is pushed towards the can body 31, the pressurized fluid in the can 30 is dispensed through the port 42. In the example embodiment depicted in the figures, the actuator 34 includes a first or upper portion 38 having a first diameter (or cross-sectional dimension) and a second or lower portion 40 (i.e., closer to the body of the can) having a larger diameter (or cross-sectional dimension). In other words, the nozzle 34 is a two-part nozzle. A shelf or actuator surface 36 is created where the first portion 38 and the second portion 40 meet and is a substantially flat and annular or ring-shaped surface. Although the actuator of the depicted embodiment shows two substantially cylindrical portions 38 and 40 having a substantially circular cross-section, other suitably sized and shaped actuators can be employed as well. For example, in alternative embodiments, a cross-section of the actuator can be square, rectangular, oval, triangular, trapezoidal, etc. The actuator 34 also has a port 42 at the top surface thereof through which the fluid is dispensed. Spray cans having two-part push-button nozzles are generally well known and will not be described in further detail herein. Many different varieties of spray cans, including aerosol cans, exist, and actuation devices of the present invention can be compatible with all such varieties having a push-button nozzle.

In example embodiments, the actuation device 10 comprises a unitary piece having a handle 12, a top portion 14, a living hinge 16, and a pair of extensions 18a and 18b, as shown in FIG. 1. The device 10 can be made from a variety of materials, including, but not limited to, steel, stainless steel, aluminum, iron, plastic, or any other suitable and resilient material capable of undergoing elastic deformation. In a typical commercial embodiment, the actuation device 10 is constructed from a thin sheet of metal, such as from 1/32″ thick steel, although thicker or thinner material can be used as desired. Optionally, the device 10 can be coated with one or more coatings, such as paint and/or a rust proof coating.

In example embodiments, the top portion 14 is a substantially rectangular surface, although in other embodiments, the top portion can have any suitably sized and shaped surface, including oval. The handle 12 extends at an oblique angle a from a first end of the top portion 14. For example, in an example embodiment, the angle a can be about 100° to about 150°. Preferably, the angle α is about 110°. In other embodiments, the angle α can be less than about 100° (including 90°) or greater than about 150°.

In the depicted embodiment, the handle 12 is shown as a somewhat rectangular member with a contour generally conforming to the contour of the cylindrical spray can body 31. In other embodiments, the handle 12 can be shaped differently to be more ergonomic, to meet other design or functional purposes, or as desired by a user. Optionally, the handle can be padded or include finger grooves or grips for user comfort. The handle 12 can optionally include a small aperture or hole 13 formed therein. In the depicted embodiment, the aperture 13 is located near the free end of the handle 12, although the aperture 13 can be located at any suitable place on the device 10. The aperture 13 can be used for multiple purposes, e.g., attaching a lanyard therethrough and/or for hanging the device 10 on a screw on a wall, etc. Together, the top portion 14 and the handle 12 function as a lever.

The opposite end (i.e., second end) of the top portion 14 from the handle 12 includes a living hinge 16. The living hinge 16 in the depicted embodiment is a rounded or curved hinge with a radius of curvature. In other words, a cross-section of the living hinge 16 can be substantially U-shaped. Extending from the free end of the living hinge 16 are at least one and preferably a pair of fingers or extensions 18a and 18b that are configured to engage the can 30 between the curl 33 and the can body 31 and to help secure the device 10 to the can 30. In the depicted embodiment, there the two extensions 18a and 18b located near the opposing lateral edges of the living hinge 16 and together form a yoke or engaging surface 20. In the depicted embodiment, the engaging surface 20 is substantially U-shaped. The extensions 18a and 18b can be bent as shown in FIG. 3 to conform to the contour of the can body 31, or the extensions 18a and 18b can be substantially straight. In the depicted embodiment, the yoke 20 has a substantially curved inner collar 21 that is similar in shape to the curl of the can, but in other embodiments, the collar 21 can have a different shape.

In a typical commercial embodiment, the length L1 of the handle 12 is about 5 inches (12.7 cm) and the length L2 of the top portion 14 is about 2.5 inches (6.35 cm). The width W of the device 10 is about 1.5 inches (3.81 cm), and the height H defined between the top portion 14 and the yoke 20 is about 0.75 inches (1.905 cm). However, these dimensions can vary in other embodiments, as desired. For example, the length L1 of the handle 12, the length L2 of the top portion 14, and the height H can depend on, for example, the type of spray can on which the actuation device is to be used on, or can vary with user preference (e.g., if a user prefers a short, medium, or long handle).

The top portion 14 also includes an opening or an elongated slot 22 therein. The elongated slot 22 extends generally along the axis of elongation of the top portion 14 as depicted in the drawing figures. Alternatively, in other embodiments, the slot can extend along substantially the entire length L2 of the top portion or can be circular or elliptical in shape (or otherwise shaped as desired). In the depicted embodiment, the slot 22 has rounded ends, but in other embodiments, the slot 22 may have other suitably-shaped ends. Preferably, the elongated slot 22 is sized and shaped to receive only a portion of the can's actuator (e.g., the upper portion 38) therethrough. In other words, the width of the slot is slightly larger than the diameter of the upper portion 38 of the actuator 34, but smaller than the diameter of the lower portion 40 of the actuator. In a typical commercial embodiment, the elongated slot 22 has dimensions of about 1.5 inches (or 3.81 cm) long by about 0.25 inches (or 6.35 mm) wide. In other embodiments, the elongated slot 22 can be shaped differently, depending on the type of spray can and size of the can's actuator to be used with the device 10. Still alternatively, the top portion can include a plurality of slots or openings, each appropriately sized and shaped to be used with a spray can of a particular size.

In example embodiments, the device 10 is fitted onto the spray can 30 by first inserting the upper portion 38 of the actuator 34 through the elongated slot 22 near its first end (i.e., the end closest to the handle 12). The wall of the top portion 14 surrounding the slot 22 engages the shelf surface 36 of the actuator 34, thereby preventing the entire actuator (e.g., the lower portion) from extending therethrough. The yoke 20 is then inserted under the valve cup 32 of the spray can 30 while the actuator 34 is simultaneously slid towards the end of the elongated slot 22 closest to the living hinge 16. The yoke 20 of the device 10 is fitted between the valve cup 32 of the spray can 30 and the can body 31 by a friction fit or by an interference fit. As shown in FIGS. 3-5, the valve cup 32 of the can 30 preferably rests above the collar 21 of the yoke 20. The extensions 18a and 18b provide pressure between the valve cup 32 of the can 30 and the rest of the can body 31. The angle of the extensions 18a and 18b provide tension between the under surface of the valve cup 32 and curl 33 and the outer surface of the can body 31 and helps secure the device 10 to the can 30. In preferred embodiments, tension between the extensions 18a and 18b is such that a tight fit is developed between the same (e.g., preferably the device isn't “loose” against the can).

Accordingly, the device 10 is secured to the can 30, but does not include a separate locking mechanism. Thus, the device 10 can be easily removed and reused with other cans. When the device 10 is secured to the can 30, the actuator 34 is positioned near the end of the slot 22 closest to the living hinge 16. However, the working position of the actuator 34 in the slot 22 can vary depending on the size and/or shape of a particular can.

FIG. 5 shows the device 10 being used to activate the actuator 34 of the spray can 30. A user applies a compression force, marked by the arrow A, to the handle 12 with his hand, which then forces the top portion 14 towards the can 30, thereby applying a compressive force to the actuator surface 36 and activating the actuator 34. The actuator 34 then releases a fluid S. The living hinge 16 allows the top portion 14 to be bent towards the can (i.e., active state) when the force A is applied to the handle 12 and then return to its original orientation (i.e., static state) when the force A on the handle 12 is released, due to elastic deformation. When the force A is released, the flow of fluid through the actuator 34 stops. When the force A is applied, the yoke 20 and the extensions 18a and 18b function as a fulcrum, and the handle 12 and top portion 14 function as a lever. Advantageously, the device 10 provides a more uniform spray S of the fluid from the can 30 because the user is able to accurately provide a uniform compression force to the actuator 34. Also advantageously, the device 10 provides the user a better and more comfortable grip.

In an example embodiment, a spray can housing a fluid (e.g., an adhesive, paint, cleaner, deodorant, hair spray, or insecticide), a two-part nozzle, and an actuation device 10 of the present invention can be packaged together into a single kit. The two-part nozzle includes a first part that has a smaller cross-sectional dimension than the cross-sectional dimension of the second part. The two-part nozzle can be removably attached to a valve stem portion of the spray can.

In example embodiments, the present invention provides actuation devices for use with “upside down spray cans” with two-part nozzles. Typically, spray cans are used upright (i.e., when the nozzle is at a higher elevation that then the curl of the can). An upside down spray can be used when the nozzle is at a lower elevation than the curl, such as when spraying a floor. The actuation devices of the present invention, when attached to upside down spray cans, allow a user to provide a more uniform spray of the fluid from the can when spraying a floor, for example.

The device 10 can be configured to fit onto any spray can with any spray tip or nozzle. It should be understood that the device 10 can be used for not only spray cans with a vertical spray tip, but with a horizontal spray tip, a tilt spray tip, or any other type of oriented spray tip. Preferably, the device 10 is removably attached to the can 30 so that the device can be reused with other cans. In an alternative embodiment, the engaging member for engaging the curl of the can be can be substantially annular. The annular engaging member can be urged over the curl and “snapped” into a permanent engagement such that the device cannot be removed from the can. In such an embodiment, one or more teeth or extensions can further secure the device to the can.

However, in alternative embodiments, the device 10 can be permanently installed on a spray can, such as with an adhesive. In alternative embodiments, the actuation device can be part of the spray can, such through molding, casting, and/or welding the can and actuation device together.

While the invention has been described with reference to preferred and example embodiments, it will be understood by those skilled in the art that a variety of modifications, additions, and deletions are within the scope of the invention, as defined by the following claims.

What is claimed is:

1. A system for dispensing a fluid, comprising:
a spray can having a can body and an upper curl portion, the can body housing a pressurized fluid;
a nozzle coupled to the spray can for dispensing the pressurized fluid therethrough, wherein the nozzle further comprises first and second portions, wherein the first portion of the nozzle has a smaller cross-sectional dimension than a cross-sectional dimension of the second portion; and
an actuation lever attached to the can, the actuation lever having a proximal end, a distal end, an elongated slot extending along a portion thereof and configured to receive at least the first portion of the nozzle therethrough, and an engaging surface extending from the proximal end of the lever, wherein the engaging surface engages the curl portion of the can and at least partially secures the lever to the can,
whereby when a force is applied to the distal end of the lever to urge the lever towards the can, the actuation lever depresses the nozzle to thereby dispense the pressurized fluid therethrough.

2. The system of claim 1, wherein the lever includes a living hinge.

3. The system of claim 1, wherein the lever is constructed of a resilient material.

4. The system of claim 3, wherein the resilient material is a sheet of metal.

5. The system of claim 1, wherein the actuation lever is removably attached to the can.

6. The system of claim 1, wherein the actuation lever is permanently attached to the can.

7. The system of claim 1, wherein the engaging surface is substantially U-shaped.

8. An actuation device for a spray can having a push-button nozzle, comprising:
a substantially U-shaped hinge having first and second arms, wherein the first arm includes a yoke for attachment to the spray can and the second arm includes an opening therethrough, wherein the opening is dimensioned to receive a portion of the nozzle therethrough; and
a handle extending at an oblique angle from the second arm,
whereby when the actuation device is fitted to the can such that the yoke engages the can, the portion of the nozzle is positioned through the opening, and upon a force being applied to the handle to urge the handle towards the can, the second arm depresses the nozzle to thereby dispense a fluid therethrough.

9. The actuation device of claim 8, wherein the device is constructed of a resilient material.

10. The actuation device of claim 9, wherein the resilient material is a sheet of metal.

11. The actuation device of claim 8, wherein the opening is an elongated slot.

12. The actuation device of claim 8, wherein the handle is contoured.

13. The actuation device of claim 8, wherein the U-shaped hinge, the arms, and the handle comprise a unitary member.

14. A kit, comprising:
a spray can housing a pressurized fluid therein and having a curl adjacent a nozzle assembly;
a two-part nozzle, wherein a first part of the nozzle has a smaller cross-sectional dimension than a cross-sectional dimension of a second part of the nozzle; and
an actuation lever, comprising:
a first portion having an opening therein, wherein the opening is configured to receive at least the first part of the two-part nozzle;
a handle extending from a first end of the first portion, and
an engaging surface extending from a second end of the first portion, wherein the engaging surface is configured to engage the curl of the can to secure the lever to the can.

15. The kit of claim 14, wherein the engaging surface of the actuation lever is a substantially U-shaped engaging surface.

16. A spray can of the type comprising a curl portion at the top of the can and a nozzle through which a pressurized fluid is dispensed through a top portion thereof, the improvement therein comprising:
an actuation device attached to the curl portion of the can, wherein the actuation device comprises:
a lever, wherein the lever has a first portion having an opening extending therethrough and a second portion extending from the first portion for providing a handle, and
an engaging surface at a proximal end of the lever, wherein the engaging surface engages the curl portion of the can; and
whereby when a force is applied to the handle to urge the handle towards the can, the lever depresses the nozzle to thereby dispense the pressurized fluid therethrough.

17. The improvement of claim 16, wherein the actuation device is a unitary piece.

18. The improvement of claim 16, wherein the actuation device is constructed of a resilient material.

19. The improvement of claim 16, wherein the actuation device is removably attached to the can.

20. The improvement of claim 16, wherein the handle is contoured.
